(19) United States
(12) Patent Application Publication
(10) Pub. No.: US 2010/0115986 A1
(43) Pub. Date: May 13, 2010

(54) INTELLIGENT DIGITAL CONTROL APPARATUS FOR WINE TEMPERATURE

(76) Inventor: Chingmiao Wilson WANG, Guangdong (CN)

Correspondence Address: Dr. BANGER SHIA;Patent Office of Bang Shia, 102 Lindencrest Ct., Sugar Land, TX, 77479-5201, US

(21) Appl. No.: 12/530,177

(22) PCT Filed: Mar. 8, 2007
(86) PCT No.: PCT/CN07/00750

§ 371 Date: Sep. 4, 2009

(51) Int. Cl. F25D 3/08; G05B 15/00; F25B 21/00

(52) U.S. Cl. 62/457.8; 700/275; 62/457.9

(57) ABSTRACT

An intelligent digital control apparatus for wine temperature includes a tub (10), a semiconductor cooling/heating device (20), a temperature sensing device (30) and a digital control panel (40). When the wine bottle is put in the tub (10), the semiconductor cooling/heating device (20) is activated to start cooling if the setting temperature is higher than the wine temperature. The semiconductor cooling/heating device (20) begins warming when the wine temperature decreases below the setting temperature. When the wine bottle is put in the tub (10), the semiconductor cooling/heating device (20) is activated to start heating if the setting temperature is lower than the wine temperature. The semiconductor cooling/heating device (20) begins warming when the wine temperature increases over the setting temperature. The intelligent digital control apparatus senses the temperature of the wine bottle disposed in the tub (10), and thereby intelligently controls the increasing or decreasing of the temperature in the tub (10) by reasonably arranging the position among the temperature sensing device (30), the semiconductor cooling/heating device (20) and the tub (10), so that the wine in the wine bottle can be adjusted to proper temperature, and the condition of the wine temperature can be further directly reflected with digital display.

### BACKGROUND OF THE INVENTION

1. Field of the Invention

The present invention relates to a wine warmer, and more particularly to an intelligent digital control apparatus having a semiconductor cooling/heating device for wine temperature.

2. Description of the Prior Art

People are more and more fastidious about food and drink as standard of living is rising continuously. Now, there are many brands of wine on the market. The flavor of most wine will be different when the wine temperature is changed. In general, a wine warmer is used to adjust the wine temperature when testing wine. As implied in the name, a wine warmer is designed for controlling the wine temperature. A conventional wine warmer uses a probe of a temperature sensing device to contact with an inner container for conducting heat. Alternatively, an insulation layer is provided between the bottom and the wall of the inner container. However, the conventional warmer is unable to get the temperature accurately when in use.

Chinese Patent No. 2005201326796 discloses a wine container/beverage semiconductor cooling/heating device, which uses a semiconductor cooling/heating apparatus and a LCD to solve the problem of temperature adjustment. But, it adopts a temperature measuring member which is mounted in a traditional way, which is also unable to get the temperature accurately. Accordingly, the inventor of the present invention has devoted himself based on his many years of practical experiences to solve this problem.

### SUMMARY OF THE INVENTION

The primary object of the present invention is to provide an intelligent digital control apparatus for wine temperature, which comprises a temperature sensing device, a semiconductor cooling/heating device and a tub mounted at a proper position to sense the temperature of a wine bottle in the tub and then to rise or lower the temperature intelligently so that the wine in the wine bottle is adjusted to an appropriate temperature for a better flavor. With the temperature sensing device cooperated with metallic parts to sense the temperature of the wine bottle, the wine temperature is displayed on a digital display. This is convenient when in use.

According to a first aspect of the present invention, there is provided an intelligent digital control apparatus for wine temperature, comprising:

a tub comprising an inner container for insertion of a wine bottle and an outer shell wrapping the inner container, the inner container including a metallic wall and a metallic bottom which is adiabatic to the metallic wall and gets in touch with a bottom of the wine bottle;

a semiconductor cooling/heating device disposed in a chamber formed between the metallic wall and the outer shell, the semiconductor cooling/heating device including a semiconductor cooling/heating plate, a heat sink module, and an electric control module for controlling the semiconductor cooling/heating plate and the heat sink module, the semiconductor cooling/heating plate being attached to an outside of the metallic wall for controlling the temperature of the metallic wall, the heat sink module being disposed behind the semiconductor cooling/heating plate;

a temperature sensing device disposed under the metallic bottom for sensing the temperature of the metallic bottom to get the temperature of the wine bottle indirectly, the temperature sensing device being electrically connected to the electric control module; and a digital control panel mounted on the outer shell, the digital control panel including a digital display and an operating key unit, the digital display and the operating key unit being electrically connected to the electric control module, respectively.

Preferably, the electric control module includes a power supply circuit, a single-chip control system circuit, and a relay control circuit, the power supply circuit supplying power to the single-chip control system circuit and the digital display, the single-chip control system circuit being electrically connected with the temperature sensing device, the operating key unit and the relay control circuit, the relay control circuit being electrically connected with the semiconductor cooling/heating plate and the heat sink module, the temperature sensing device and the operating key unit providing electric signals to the single-chip control system circuit for processing to control the operation of the relay control circuit, the relay control circuit controlling cooling or heating of the semiconductor cooling/heating plate.

Preferably, the power supply circuit is connected to a temperature protection circuit.

Preferably, the temperature sensing device is a temperature sensing wire.

Preferably, the metallic bottom is made of aluminum.

Preferably, the heat sink module includes a plurality of heat sink fins and a fan behind the heat sink fins.

Preferably, an adiabatic layer is provided between the metallic wall and the metallic bottom.

According to a second aspect of the present invention, there is provided an intelligent digital control apparatus for wine temperature, comprising:

a tub comprising an inner container for insertion of a wine bottle and an outer shell wrapping the inner container, the inner container including a metallic wall and a metallic bottom which is integrally formed with the metallic wall, an elastic metallic arm being suspended on an inner side of the metallic wall, the elastic metallic arm being adiabatic to the metallic wall and getting in touch with an outside of the wine bottle;

a semiconductor cooling/heating device disposed in a chamber formed between the metallic bottom and the outer shell, the semiconductor cooling/heating device including a semiconductor cooling/heating plate, a heat sink module, and an electric control module for controlling the semiconductor cooling/heating plate and the heat sink module, the semiconductor cooling/heating plate being disposed under the metallic bottom for controlling the temperature of the metallic bottom, the heat sink module being disposed under the semiconductor cooling/heating plate;

a temperature sensing device disposed on an inner side of the elastic metallic arm for sensing the temperature of the elastic metallic arm to get the temperature of the wine bottle indirectly, the temperature sensing device being electrically connected to the electric control module; and

a digital control panel mounted on the outer shell, the digital control panel including a digital display and an operating key unit, the digital display and the operating key unit being electrically connected to the electric control module, respectively.

Preferably, the electric control module includes a power supply circuit, a single-chip control system circuit, and a relay control circuit, the power supply circuit supplying power to the single-chip control system circuit and the digital display, the single-chip control system circuit being electrically connected with the temperature sensing device, the operating key unit and the relay control circuit, the relay control circuit being electrically connected with the semiconductor cooling/heating plate and the heat sink module, the temperature sensing device and the operating key unit providing electric signals to the single-chip control system circuit for processing to control the operation of the relay control circuit, the relay control circuit controlling cooling or heating of the semiconductor cooling/heating plate.

Preferably, the power supply circuit is connected to a temperature protection circuit.

Preferably, the temperature sensing device is a temperature sensing wire.

Preferably, the elastic metallic arm is made of aluminum.

Preferably, the heat sink module includes a plurality of heat sink fins and a fan under the heat sink fins.

Preferably, an adiabatic layer is provided between the metallic wall and the elastic metallic arm.

According to a third aspect of the present invention, there is provided an intelligent digital control apparatus for wine temperature, comprising:

a tub comprising two inner containers arranged side by side for insertion of a wine bottle and an outer shell to wrap the two inner containers, each of the two inner containers including a metallic wall and a metallic bottom which is integrally formed with the metallic wall, a curved metallic plate fixed on an inner side of the metallic wall being adiabatic to the metallic wall and getting in touch with an outside of the wine bottle;

a semiconductor cooling/heating device disposed in a chamber formed between the metallic wall and the outer shell, the semiconductor cooling/heating device including two semiconductor cooling/heating plates, two heat sink modules, and an electric control module for controlling the semiconductor cooling/heating plates and the heat sink modules, the two semiconductor cooling/heating plates each being attached to an outside of the metallic wall for controlling the temperature of the metallic wall, the two heat sink modules being disposed behind the respective semiconductor cooling/heating plates;

two temperature sensing devices each disposed on an inner side of the curved metallic plate for sensing the temperature of the curved metallic plate to get the temperature of the wine bottle indirectly, the two temperature sensing devices each being electrically connected to the electric control module; and

a digital control panel mounted on the outer shell, the digital control panel including a digital display and an operating key unit, the digital display and the operating key unit being electrically connected to the electric control module, respectively.

Preferably, the electric control module includes a power supply circuit, a single-chip control system circuit, and two relay control circuits, the power supply circuit supplying power to the single-chip control system circuit and the digital display, the single-chip control system circuit being electrically connected with the two temperature sensing devices, the operating key unit and the two relay control circuits, the two relay control circuits being electrically connected with the two semiconductor cooling/heating plates and the two heat sink modules respectively, the two temperature sensing devices and the operating key unit providing electric signals to the single-chip control system circuit for processing to control the operation of the two relay control circuits, and the two relay control circuits controlling cooling or heating of the two semiconductor cooling/heating plates, respectively.

Preferably, the power supply circuit is connected to a temperature protection circuit.

Preferably, the temperature sensing device is a temperature sensing wire.

Preferably, the curved metallic plate is made of aluminum.

Preferably, the heat sink module includes a plurality of heat sink fins and a fan behind the heat sink fins.

Preferably, an adiabatic layer is provided between the metallic wall and the curved metallic plate.

Preferably, an elastic engaging plate is provided on the metallic wall for engaging with the wine bottle.

### BRIEF DESCRIPTION OF THE DRAWINGS

FIG. 1 is an exploded view according to a first embodiment of the present invention;

FIG. 2 is a perspective view according to the first embodiment of the present invention;

FIG. 3 is a partially sectional view according to the first embodiment of the present invention;

FIG. 4 is a circuit diagram according to the first embodiment of the present invention;

FIG. 5 is an exploded view according to a second embodiment of the present invention;

FIG. 6 is a perspective view according to the second embodiment of the present invention;

FIG. 7 is a partially sectional view according to the second embodiment of the present invention;

FIG. 8 is a circuit diagram according to the second embodiment of the present invention;

FIG. 9 is an exploded view according to a third embodiment of the present invention;

FIG. 10 is a perspective view according to the third embodiment of the present invention;

FIG. 11 is a partially sectional view according to the third embodiment of the present invention;

FIG. 12 is another partially sectional view according to the third embodiment of the present invention; and

FIG. 13 is a circuit diagram according to the third embodiment of the present invention.

### DETAILED DESCRIPTION OF THE PREFERRED EMBODIMENT

Embodiments of the present invention will now be described, by way of example only, with reference to the accompanying drawings.

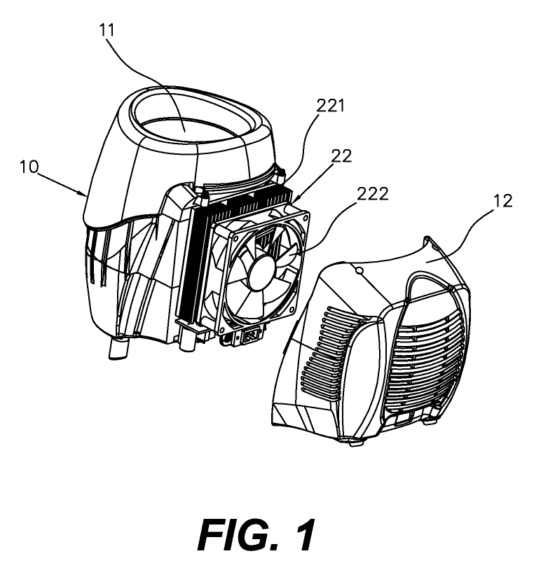

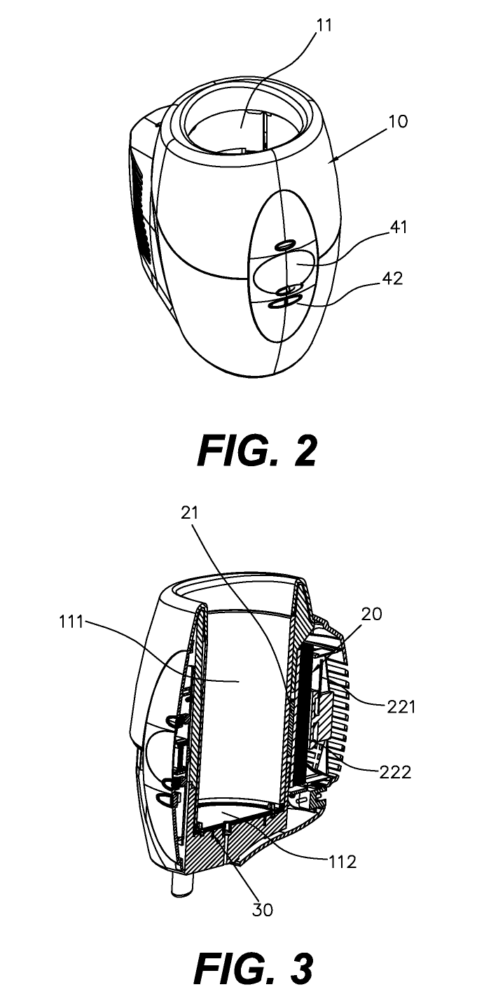

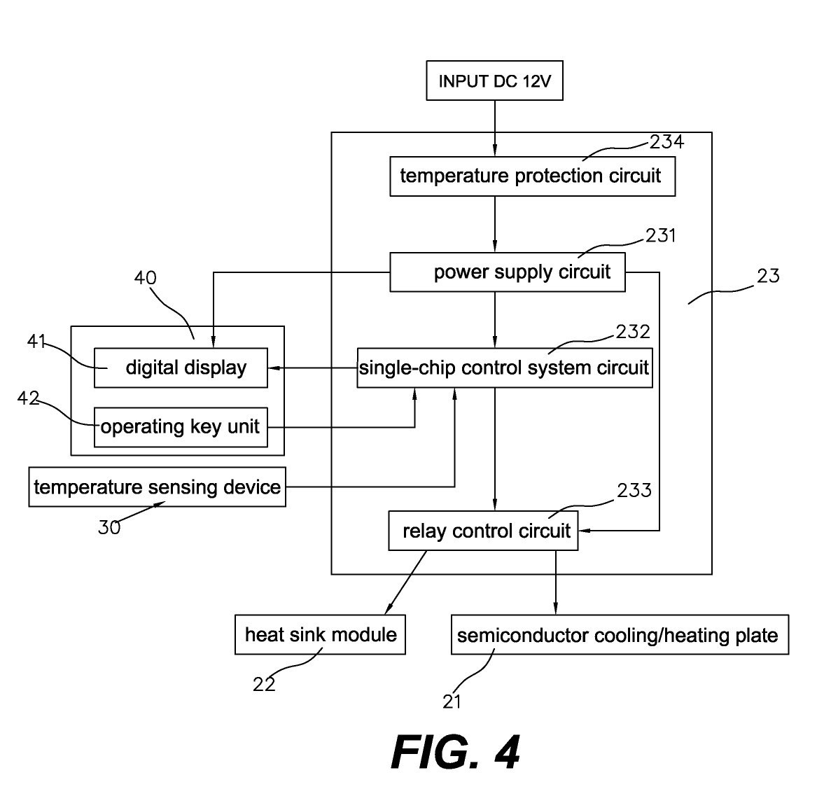

As shown in FIGS. 1 through 4, an intelligent digital control apparatus according to a first embodiment of the present invention includes a tub 10, a semiconductor cooling/heating device 20, a temperature sensing device 30, and a digital control panel 40.

The tub 10 comprises an inner container 11 for insertion of a wine bottle and an outer shell 12 wrapping the inner container 11. The inner container 11 includes a metallic wall 111 and a metallic bottom 112 which is adiabatic to the metallic wall 111 and gets in touch with the bottom of the wine bottle. Preferably, the metallic bottom 112 is made of aluminum. Between the metallic wall 111 and the metallic bottom 112 is an adiabatic layer for heat insulation, enhancing accuracy of test data.

The semiconductor cooling/heating device 20 is disposed in a chamber formed between the metallic wall 111 and the outer shell 12. The semiconductor cooling/heating device 20 includes a semiconductor cooling/heating plate 21, a heat sink module 22, and an electric control module 23 for controlling the operation of the semiconductor cooling/heating plate 21 and the heat sink module 22. The semiconductor cooling/heating plate 21 is attached to an outside of the metallic wall 111 for controlling the temperature of the metallic wall 111. The heat sink module 22 includes a plurality of heat sink fins 221 and a fan 222 behind the heat sink fins 221. The heat sink fins 221 are disposed behind the semiconductor cooling/heating plate 21 for heat dissipation so as to protect the normal operation of the semiconductor cooling/heating plate 21.

The temperature sensing device 30 can be a temperature sensing wire disposed under the metallic bottom 112 for sensing the temperature of the metallic bottom 112 to get the temperature of the wine bottle indirectly. The temperature sensing device 30 is electrically connected to the electric control module 23.

The digital control panel 40 is mounted on the outer shell 12. The digital control panel 40 includes a digital display 41 and an operating key unit 42. The digital display 41 can be a liquid crystal display. The digital display 41 and the operating key unit 42 are electrically connected to the electric control module 23, respectively.

The electric control module 23 includes a power supply circuit 231, a single-chip control system circuit 232, and a relay control circuit 233. The power supply circuit 231 is adapted to supply power to the single-chip control system circuit 232 and the digital display 41. The single-chip control system circuit 232 is electrically connected with the temperature sensing device 30, the operating key unit 42 and the relay control circuit 233. The relay control circuit 233 is electrically connected with the semiconductor cooling/heating plate 21 and the heat sink module 22. The temperature sensing device 30 and the operating key unit 42 provide electric signals to the single-chip control system circuit 232 for processing so as to control the operation of the relay control circuit 233, and then the relay control circuit 233 controls cooling or heating of the semiconductor cooling/heating plate 21. The power supply circuit 231 is further connected to a temperature protection circuit 234.

To practice the first embodiment, the wine bottle filled with wine is placed in the inner container 11, with the bottom of the wine bottle being contact with the metallic bottom 112 of the inner container 11. The temperature sensing device 30 disposed under the metallic bottom 112 direct senses the temperature of the bottom of the wine bottle so that the real temperature of the wine is calculated and displayed on the digital display 41. If the setting temperature is higher than the wine temperature, the semiconductor cooling/heating device 20 is activated to start cooling to lower the temperature of the metallic wall 111 and then lower the temperature in the inner container 11 so that the wine temperature is cooled down. When the wine temperature is lowered to the setting temperature, the temperature will stay warm. On the contrary, if the setting temperature is lower than the wine temperature, the semiconductor cooling/heating device 20 is activated to start heating to rise the temperature of the metallic wall 111 and then rise the temperature in the inner container 11 so that the wine temperature is risen. When the wine temperature is risen to the setting temperature, the temperature will stay warm.

The first embodiment uses the temperature sensing device to sense the temperature of the metallic bottom of the inner container for sensing the temperature of the wine bottle which is contact with the metallic bottom. The semiconductor cooling/heating device is adapted to lower or rise the temperature in the inner container so that the wine in the wine bottle is adjusted to an appropriate temperature for a better flavor. The digital display is adapted to display the wine temperature direct, which is convenient when in use.

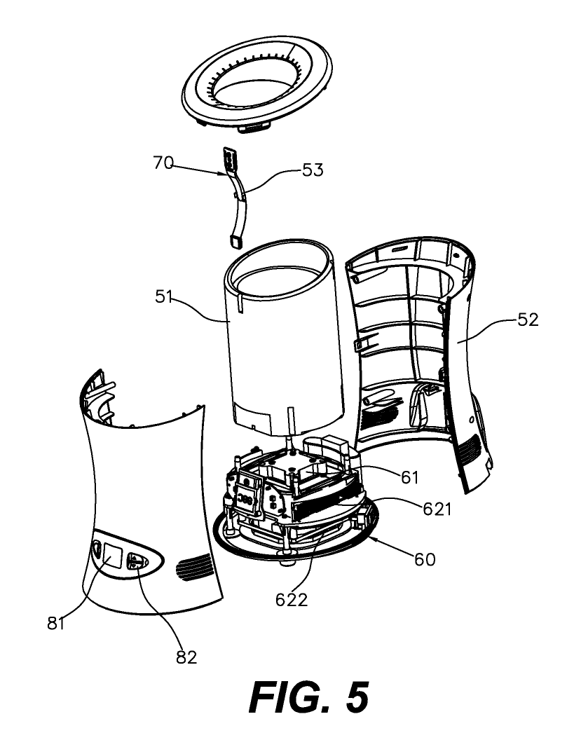

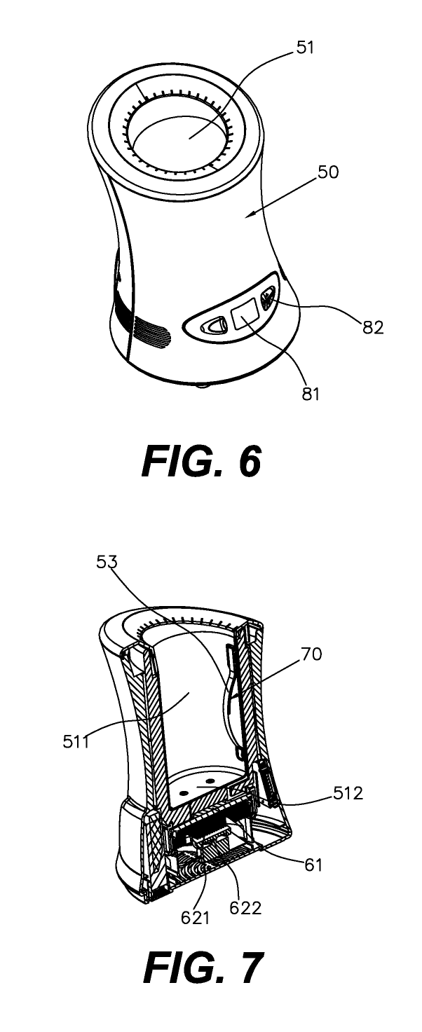

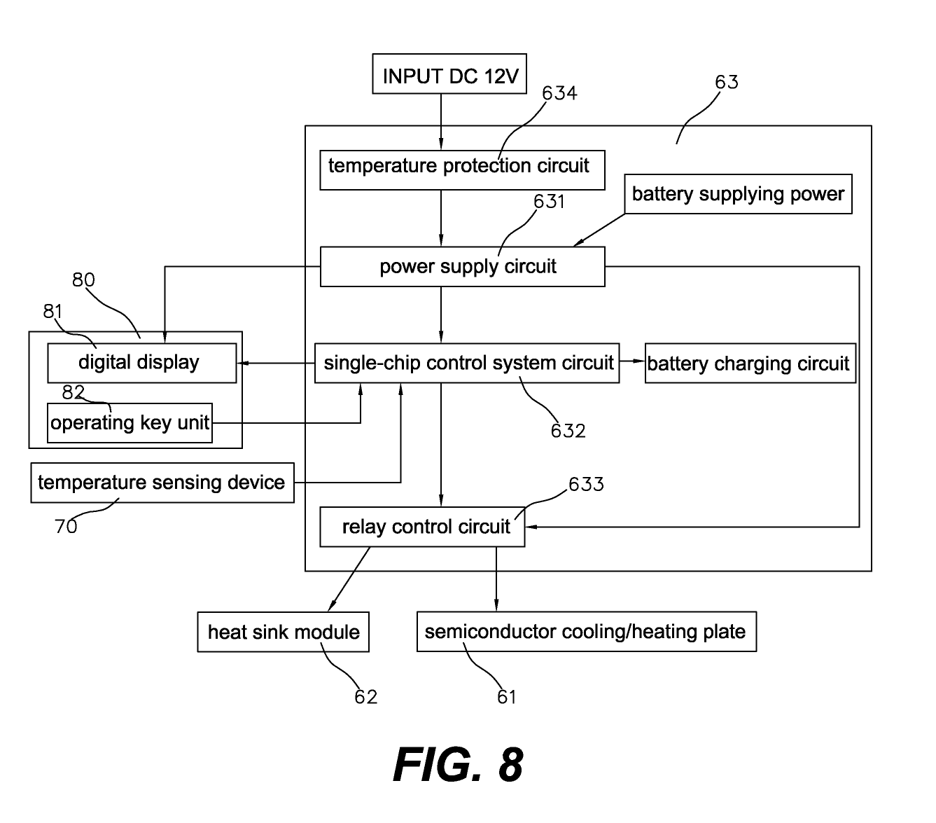

As shown in FIGS. 5 through 8, an intelligent digital control apparatus according to a second embodiment of the present invention includes a tub 50, a semiconductor cooling/heating device 60, a temperature sensing device 70, and a digital control panel 80.

The tub 50 comprises an inner container 51 for insertion of a wine bottle and an outer shell 52 wrapping the inner container 51. The inner container 51 includes a metallic wall 511 and a metallic bottom 512 which is integrally formed with the metallic wall 511. An elastic metallic arm 53 is suspended on an inner side of the metallic wall 511, which is adiabatic to the metallic wall 511 and gets in touch with the outside of the wine bottle.

Preferably, the elastic metallic arm 53 is made of aluminum. Between the metallic wall 511 and the elastic metallic arm 53 is an adiabatic layer for heat insulation.

The semiconductor cooling/heating device 60 is disposed in a chamber formed between the metallic bottom 512 and the outer shell 52. The semiconductor cooling/heating device 60 includes a semiconductor cooling/heating plate 61, a heat sink module 62, and an electric control module 63 for controlling the operation of the semiconductor cooling/heating plate 61 and the heat sink module 62. The semiconductor cooling/heating plate 61 is disposed under the metallic bottom 512 for controlling the temperature of the metallic bottom 512. The heat sink module 62 includes a plurality of heat sink fins 621 and a fan 622 under the heat sink fins 621. The heat sink fins 621 are disposed under the semiconductor cooling/heating plate 61 for heat dissipation so as to protect the normal operation of the semiconductor cooling/heating plate 61.

The temperature sensing device 70 can be a temperature sensing wire disposed on an inner side of the elastic metallic arm 53 for sensing the temperature of the elastic metallic arm 53 to get the temperature of the wine bottle indirectly. The temperature sensing device 70 is electrically connected to the electric control module 63.

The digital control panel 80 is mounted on the outer shell 52. The digital control panel 80 includes a digital display 81 and an operating key unit 82. The digital display 81 can be a liquid crystal display. The digital display 81 and the operating key unit 82 are electrically connected to the electric control module 63, respectively.

The electric control module 63 includes a power supply circuit 631, a single-chip control system circuit 632, and a relay control circuit 633. The power supply circuit 631 is adapted to supply power to the single-chip control system circuit 632 and the digital display 81. The single-chip control system circuit 632 is electrically connected with the temperature sensing device 70, the operating key unit 82 and the relay control circuit 633. The relay control circuit 633 is electrically connected with the semiconductor cooling/heating plate 61 and the heat sink module 62. The temperature sensing device 70 and the operating key unit 82 provide electric signals to the single-chip control system circuit 632 for processing so as to control the operation of the relay control circuit 633, and then the relay control circuit 633 controls cooling or heating of the semiconductor cooling/heating plate 61. The power supply circuit 631 is further connected to a temperature protection circuit 634.

To practice the second embodiment, the wine bottle filled with wine is placed in the inner container 51, with the wine bottle being contact with the elastic metallic arm 53. The temperature sensing device 70 disposed on the inner side of the elastic metallic arm 53 direct senses the temperature of the wine bottle so that the real temperature of the wine is calculated and displayed on the digital display 81. If the setting temperature is higher than the wine temperature, the semiconductor cooling/heating device 70 is activated for the semiconductor cooling/heating plate 61 to start cooling to lower the temperature of the metallic bottom 512 and then to lower the temperature in the inner container 51 so that the wine temperature is cooled down. When the wine temperature is lowered to the setting temperature, the temperature will stay warm. On the contrary, if the setting temperature is lower than the wine temperature, the semiconductor cooling/heating device 70 is activated for the semiconductor cooling/heating plate 61 to start heating to rise the temperature of the metallic bottom 512 and then to rise the temperature in the inner container 51 so that the wine temperature is risen. When the wine temperature is risen to the setting temperature, the temperature will stay warm.

A test shows that the present invention is connected with external power supply at a room temperature of 25□; the temperature displayed on the LCD is the initial temperature of the wine sensed by the temperature sensing device; and the setting temperature in the tub is 10□. When the temperature is higher than 10□, the semiconductor cooling/heating device is activated to start cooling. To consider the problem that the data of the wine temperature displayed on the LCD in earlier three minutes is not steady, so the data is based on the date which is read after three minutes. When the setting temperature is lower than the wine temperature, the apparatus starts cooling. After sixty minutes, wine 750 ml will be lowered about 5±1□. After one hundred twenty minutes, the wine will be further lowered about 5±1□. When the setting temperature is higher than the wine temperature, the apparatus starts heating. After thirty minutes, wine 750 ml will be risen about 3±5□. After sixty minutes, the wine will be further risen about 3±5□.

The second embodiment is substantially similar to the first embodiment with the exceptions described hereinafter. The second embodiment uses the temperature sensing device to sense the temperature of the elastic metallic arm for sensing the temperature of the wine bottle which is contact with the elastic metallic arm. The semiconductor cooling/heating device is adapted to lower or rise the temperature in the inner container so that the wine in the wine bottle is adjusted to an appropriate temperature for a better flavor. The semiconductor cooling/heating device is disposed under the metallic bottom. The digital display is adapted to display the wine temperature direct, which is convenient when in use.

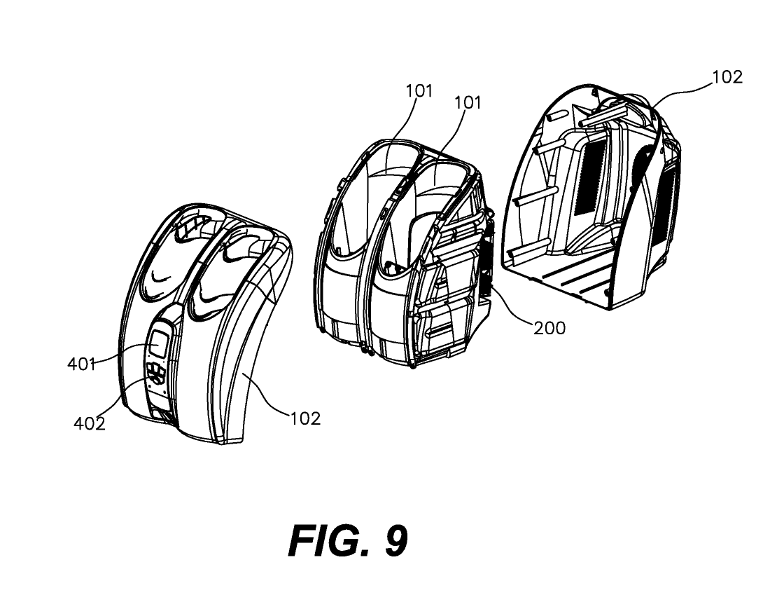

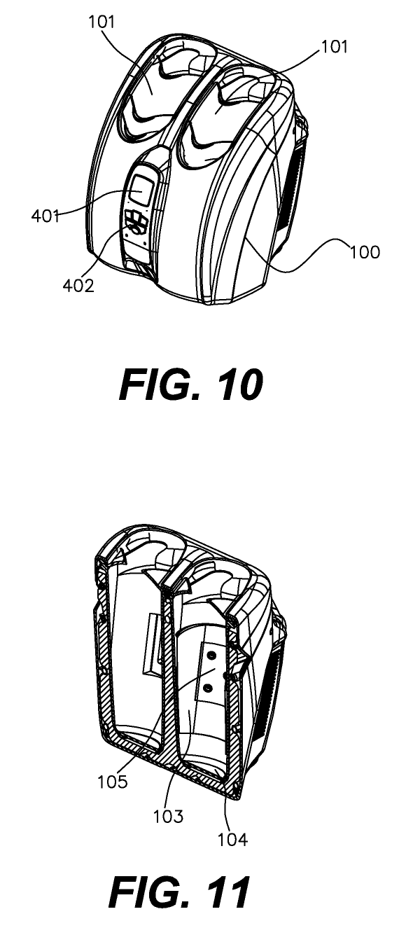

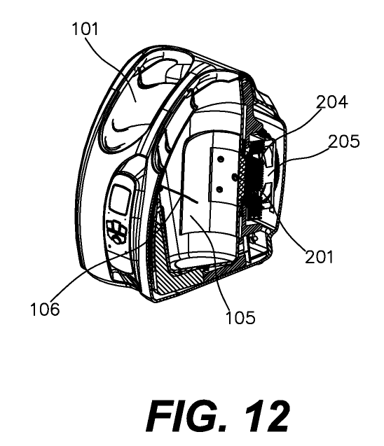

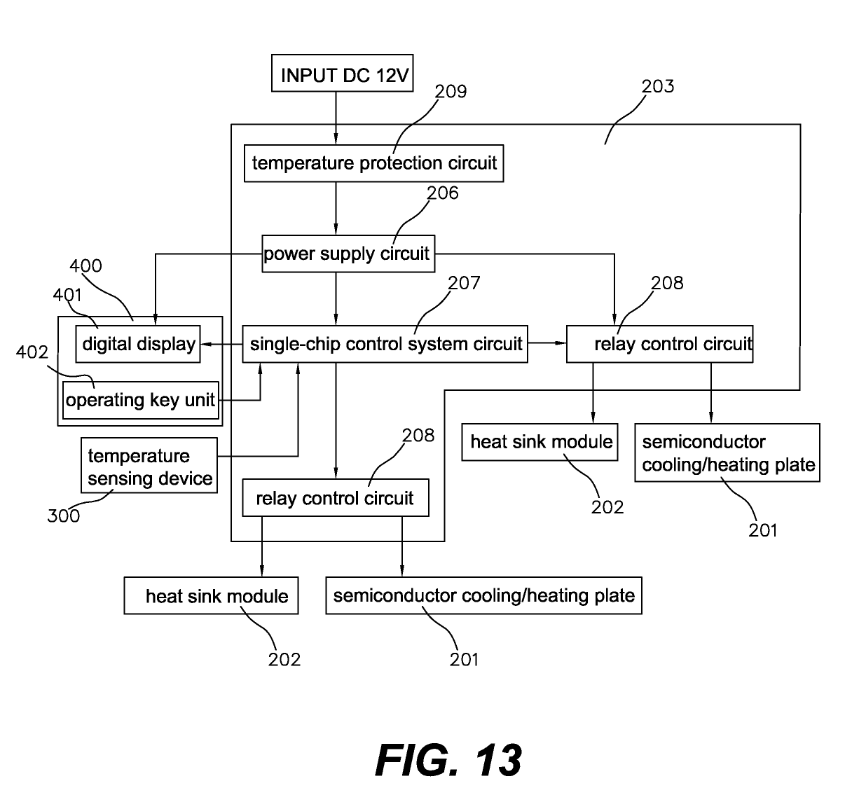

As shown in FIGS. 9 through 13, an intelligent digital control apparatus according to a third embodiment of the present invention includes a tub 100, a semiconductor cooling/heating device 200, two temperature sensing devices 300, and a digital control panel 400.

The tub 100 comprises two inner containers 101 arranged side by side for insertion of wine bottles and an outer shell 102 to wrap the two inner containers 101. Each inner container 101 includes a metallic wall 103 and a metallic bottom 104 which is integrally formed with the metallic wall 103. A curved metallic plate 105 is fixed on an inner side of the metallic wall 103, which is adiabatic to the metallic wall 103 and gets in touch with the outside of the wine bottle. Preferably, the curved metallic plate 105 is made of aluminum. Between the metallic wall 103 and the curved metallic plate 105 is an adiabatic layer for heat insulation. An elastic engaging plate 106 is provided on the metallic wall 103 for engaging with the wine bottle.

The semiconductor cooling/heating device 200 is disposed in a chamber formed between the metallic wall 103 and the outer shell 102. The semiconductor cooling/heating device 200 includes two semiconductor cooling/heating plates 201, two heat sink modules 202, and an electric control module 203 for controlling the operation of the two semiconductor cooling/heating plates 201 and the two heat sink modules 202. The two semiconductor cooling/heating plates 201 are attached to respective outsides of the metallic walls 103 for controlling the temperature of the metallic wall 103. The two heat sink modules 202 are disposed behind the two semiconductor cooling/heating plates 201, respectively. Each heat sink module 202 includes a plurality of heat sink fins 204 and a fan 205 behind the heat sink fins 204 for heat dissipation so as to protect the normal operation of the semiconductor cooling/heating plates 201.

Each of the two temperature sensing devices 300 can be a temperature sensing wire disposed on an inner side of the curved metallic plate 105 for sensing the temperature of the curved metallic plate 105 to get the temperature of the wine bottle indirectly. Each temperature sensing device 300 is electrically connected to the electric control module 203.

The digital control panel 400 is mounted on the outer shell 102. The digital control panel 400 includes a digital display 401 and an operating key unit 402. The digital display 401 can be a liquid crystal display. The digital display 401 and the operating key unit 402 are electrically connected to the electric control module 203, respectively.

The electric control module 203 includes a power supply circuit 206, a single-chip control system circuit 207, and two relay control circuits 208. The power supply circuit 206 is adapted to supply power to the single-chip control system circuit 207 and the digital display 401. The single-chip control system circuit 207 is electrically connected with the temperature sensing device 300, the operating key unit 402 and the two relay control circuits 208. The two relay control circuits 208 are electrically connected with the two semiconductor cooling/heating plates 201 and the two heat sink modules 202, respectively. The two temperature sensing devices 300 and the operating key unit 402 provide electric signals to the single-chip control system circuit 207 for processing so as to control the operation of the two relay control circuits 208, and then the two relay control circuits 208 control cooling or heating of the two semiconductor cooling/heating plates 201. The power supply circuit 206 is further connected to a temperature protection circuit 209.

To practice the third embodiment, the wine bottle filled with wine is placed in the inner container 101, with the wine bottle being contact with the curved metallic plate 105. The temperature sensing device 300 disposed on the inner side of the curved metallic plate 105 direct senses the temperature of the wine bottle so that the real temperature of the wine is calculated and displayed on the digital display 401. Like the first and second embodiments, the semiconductor cooling/heating device 200 is activated for working if the setting temperature is higher or lower than the wine temperature. Therefore, the details don't be repeated hereinafter. A test shows that under a room temperature of 25□, wine 750 ml at a temperature of 25 □ will be lowered about 5 □ within one hour; wine 750 ml at a temperature of 5 □ will be risen about 10 □ within thirty minutes.

Compared with the first and second embodiments, the third embodiment uses the temperature sensing device to sense the temperature of the curved metallic plate for sensing the temperature of the wine bottle which is contact with the curved metallic plate. The semiconductor cooling/heating device is adapted to lower or rise the temperature in the inner container so that the wine in the wine bottle is adjusted to an appropriate temperature for a better flavor. The digital display is adapted to display the wine temperature direct, which is convenient when in use. However, the semiconductor cooling/heating device in the third embodiment is disposed on one side of the metallic wall (like the first embodiment), and the tub is composed of two inner containers.

According to the aforesaid three embodiments, the cooling function of the semiconductor cooling/heating device adopts a software compensation method through a value collected by NTC (negative temperature coefficient) to compare and correct the real wine temperature which is displayed on the LCD. The heating function of the semiconductor cooling/heating device adopts PWM (pulse width modulation) to compare with the heating time of the cooling/heating plate for controlling the cooling/heating plate to work steadily within a desired temperature.

The feature of the present invention is that the temperature sensing device, the semiconductor cooling/heating device and the tub are mounted at a proper position to sense the temperature of the wine bottle in the tub and then to rise or lower the temperature intelligently so that the wine in the wine bottle is adjusted to an appropriate temperature for a better flavor. With the temperature sensing device cooperated with the metallic parts to sense the temperature of the wine bottle, the wine temperature is displayed on the digital display. This is convenient when in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An intelligent digital control apparatus for wine temperature, comprising:
a tub comprising an inner container for insertion of a wine bottle and an outer shell wrapping the inner container, the inner container including a metallic wall and a metallic bottom which is adiabatic to the metallic wall and gets in touch with a bottom of the wine bottle;
a semiconductor cooling/heating device disposed in a chamber formed between the metallic wall and the outer shell, the semiconductor cooling/heating device including a semiconductor cooling/heating plate, a heat sink module, and an electric control module for controlling the semiconductor cooling/heating plate and the heat sink module, the semiconductor cooling/heating plate being attached to an outside of the metallic wall for controlling the temperature of the metallic wall, the heat sink module being disposed behind the semiconductor cooling/heating plate;
a temperature sensing device disposed under the metallic bottom for sensing the temperature of the metallic bottom to get the temperature of the wine bottle indirectly, the temperature sensing device being electrically connected to the electric control module; and
a digital control panel mounted on the outer shell, the digital control panel including a digital display and an operating key unit, the digital display and the operating key unit being electrically connected to the electric control module, respectively.

2. The intelligent digital control apparatus for wine temperature as claimed in claim 1, wherein the electric control module includes a power supply circuit, a single-chip control system circuit, and a relay control circuit, the power supply circuit supplying power to the single-chip control system circuit and the digital display, the single-chip control system circuit being electrically connected with the temperature sensing device, the operating key unit and the relay control circuit, the relay control circuit being electrically connected with the semiconductor cooling/heating plate and the heat sink module, the temperature sensing device and the operating key unit providing electric signals to the single-chip control system circuit for processing to control the operation of the relay control circuit, the relay control circuit controlling cooling or heating of the semiconductor cooling/heating plate.

3. The intelligent digital control apparatus for wine temperature as claimed in claim 2, wherein the power supply circuit is connected to a temperature protection circuit.

4. The intelligent digital control apparatus for wine temperature as claimed in claim 1, 2 or 3, wherein the temperature sensing device is a temperature sensing wire.

5. The intelligent digital control apparatus for wine temperature as claimed in claim 1, 2 or 3, wherein the metallic bottom is made of aluminum.

6. The intelligent digital control apparatus for wine temperature as claimed in claim 1, 2 or 3, wherein the heat sink module includes a plurality of heat sink fins and a fan behind the heat sink fins.

7. The intelligent digital control apparatus for wine temperature as claimed in claim 1, 2 or 3, wherein an adiabatic layer is provided between the metallic wall and the metallic bottom.

8. An intelligent digital control apparatus for wine temperature, comprising:
a tub comprising an inner container for insertion of a wine bottle and an outer shell wrapping the inner container, the inner container including a metallic wall and a metallic bottom which is integrally formed with the metallic wall, an elastic metallic arm being suspended on an inner side of the metallic wall, the elastic metallic arm being adiabatic to the metallic wall and getting in touch with an outside of the wine bottle;
a semiconductor cooling/heating device disposed in a chamber formed between the metallic bottom and the outer shell, the semiconductor cooling/heating device including a semiconductor cooling/heating plate, a heat sink module, and an electric control module for controlling the semiconductor cooling/heating plate and the heat sink module, the semiconductor cooling/heating plate being disposed under the metallic bottom for controlling the temperature of the metallic bottom, the heat sink module being disposed under the semiconductor cooling/heating plate;
a temperature sensing device disposed on an inner side of the elastic metallic arm for sensing the temperature of the elastic metallic arm to get the temperature of the wine bottle indirectly, the temperature sensing device being electrically connected to the electric control module; and
a digital control panel mounted on the outer shell, the digital control panel including a digital display and an operating key unit, the digital display and the operating key unit being electrically connected to the electric control module, respectively.

9. The intelligent digital control apparatus for wine temperature as claimed in claim 8, wherein the electric control module includes a power supply circuit, a single-chip control system circuit, and a relay control circuit, the power supply circuit supplying power to the single-chip control system circuit and the digital display, the single-chip control system circuit being electrically connected with the temperature sensing device, the operating key unit and the relay control circuit, the relay control circuit being electrically connected with the semiconductor cooling/heating plate and the heat sink module, the temperature sensing device and the operating key unit providing electric signals to the single-chip control system circuit for processing to control the operation of the relay control circuit, the relay control circuit controlling cooling or heating of the semiconductor cooling/heating plate.

10. The intelligent digital control apparatus for wine temperature as claimed in claim 9, wherein the power supply circuit is connected to a temperature protection circuit.

11. The intelligent digital control apparatus for wine temperature as claimed in claim 8, 9 or 10, wherein the temperature sensing device is a temperature sensing wire.

12. The intelligent digital control apparatus for wine temperature as claimed in claim 8, 9 or 10, wherein the elastic metallic arm is made of aluminum.

13. The intelligent digital control apparatus for wine temperature as claimed in claim 8, 9 or 10, wherein the heat sink module includes a plurality of heat sink fins and a fan under the heat sink fins.

14. The intelligent digital control apparatus for wine temperature as claimed in claim 8, 9 or 10, wherein an adiabatic layer is provided between the metallic wall and the elastic metallic arm.

15. An intelligent digital control apparatus for wine temperature, comprising:
a tub comprising two inner containers arranged side by side for insertion of a wine bottle and an outer shell to wrap the two inner containers, each of the two inner containers including a metallic wall and a metallic bottom which is integrally formed with the metallic wall, a curved metallic plate fixed on an inner side of the metallic wall being adiabatic to the metallic wall and getting in touch with an outside of the wine bottle;
a semiconductor cooling/heating device disposed in a chamber formed between the metallic wall and the outer shell, the semiconductor cooling/heating device including two semiconductor cooling/heating plates, two heat sink modules, and an electric control module for controlling the semiconductor cooling/heating plates and the heat sink modules, the two semiconductor cooling/heating plates each being attached to an outside of the metallic wall for controlling the temperature of the metallic wall, the two heat sink modules being disposed behind the respective semiconductor cooling/heating plates;
two temperature sensing devices each disposed on an inner side of the curved metallic plate for sensing the temperature of the curved metallic plate to get the temperature of the wine bottle indirectly, the two temperature sensing devices each being electrically connected to the electric control module; and
a digital control panel mounted on the outer shell, the digital control panel including a digital display and an operating key unit, the digital display and the operating key unit being electrically connected to the electric control module, respectively.

16. The intelligent digital control apparatus for wine temperature as claimed in claim 15, wherein the electric control module includes a power supply circuit, a single-chip control system circuit, and two relay control circuits, the power supply circuit supplying power to the single-chip control system circuit and the digital display, the single-chip control system circuit being electrically connected with the two temperature sensing devices, the operating key unit and the two relay control circuits, the two relay control circuits being electrically connected with the two semiconductor cooling/heating plates and the two heat sink modules respectively, the two temperature sensing devices and the operating key unit providing electric signals to the single-chip control system circuit for processing to control the operation of the two relay control circuits, and the two relay control circuits controlling cooling or heating of the two semiconductor cooling/heating plates, respectively.

17. The intelligent digital control apparatus for wine temperature as claimed in claim 16, wherein the power supply circuit is connected to a temperature protection circuit.

18. The intelligent digital control apparatus for wine temperature as claimed in claim 15, 16 or 17, wherein the temperature sensing device is a temperature sensing wire.

19. The intelligent digital control apparatus for wine temperature as claimed in claim 15, 16 or 17, wherein the curved metallic plate is made of aluminum.

20. The intelligent digital control apparatus for wine temperature as claimed in claim 15, 16 or 17, wherein the heat sink module includes a plurality of heat sink fins and a fan behind the heat sink fins.

21. The intelligent digital control apparatus for wine temperature as claimed in claim 15, 16 or 17, wherein an adiabatic layer is provided between the metallic wall and the curved metallic plate.

22. The intelligent digital control apparatus for wine temperature as claimed in claim 15, 16 or 17, wherein an elastic engaging plate is provided on the metallic wall for engaging with the wine bottle.
